(19) United States
(12) Patent Application Publication
(10) Pub. No.: US 2015/0116309 A1
(43) Pub. Date: Apr. 30, 2015

(54) SUBTLE CAMERA MOTIONS IN A 3D SCENE TO ANTICIPATE THE ACTION OF A USER

(71) Applicant: Andrew Ofstad, San Francisco, CA (US)

(72) Inventor: Andrew Ofstad, San Francisco, CA (US)

(21) Appl. No.: 13/668,994

(22) Filed: Nov. 5, 2012

(51) Int. Cl. G06T 15/00

(52) U.S. Cl. CPC G06T 15/00
USPC 345/419

(57) ABSTRACT

A technique for providing an animated preview of a transition between two points of view can be implemented in a software application, such as a mapping application, that displays an interactive 3D representation of a geographical area and allows users to hover, hold, or otherwise indicate, without confirming a selection, a desired destination location of a viewport within the displayed 3D representation to generate the animated preview. An animated preview may include travelling a portion of a trajectory that runs between an initial position of the viewport and the desired destination position of the viewport. The mapping application temporarily moves the viewport toward the destination position of the viewport along the trajectory and then moves the viewport back to its original position. In this manner, the mapping application provides a subtle but clear indication toward the direction and orientation of the destination location of the viewport. The overall visual effect of animating the transition to the destination location of the viewport can be conceptualized as the viewport attempting to move to the destination location but restrained by an attached elastic band.

### FIELD OF TECHNOLOGY

The present invention relates to electronic mapping systems. More specifically, the present invention relates to subtle camera motions that anticipate a future user action in a three-dimensional scene.

### BACKGROUND

Currently available three-dimensional mapping systems require a simple and intuitive method to navigate a three-dimensional scene rendered onto a two-dimensional display. Some currently available mapping systems may employ a method wherein a user navigates a three-dimensional scene by selecting a desired destination in the scene with a pointing device. The mapping system in this embodiment may move the perspective of the three-dimensional scene to center on the selected destination and orient the perspective of the scene orthogonal to the selected three-dimensional surface. Navigation of a three-dimensional scene by selecting points thus requires movement through the scene, zooming, and rotating the perspective of the scene in response to a user input.

However, a user navigating a three-dimensional scene as described above may not anticipate the response of the scene to making a selection with a pointing device. For example, the user may not anticipate whether the scene will rotate and move to the selected point with the desired user perspective. Alternatively, if there is an icon to select within the three-dimensional scene and the user selects the icon with a pointing device the user may not desire to change the perspective of the scene at all. Thus, some currently available mapping systems may render a three-dimensional cursor in the three-dimensional scene to indicate to a user a future perspective of the scene if the user selects a particular point within the three-dimensional scene. This three-dimensional cursor may include for example a polygon or ellipse rendered onto a surface of the three-dimensional scene that attempts to indicate to the user the future perspective or orientation of the scene if the user selects that particular point in the scene. In this particular embodiment, the three-dimensional cursor would indicate to the user that the scene would change perspective and orientation in response to a selection with a pointing device, or alternatively that the scene would not change if the user selects an icon. However, this embodiment still does not provide the user with a preview or understanding of the movement of the three-dimensional scene and the user may experience unexpected results when the user selects a point within the three-dimensional scene. For example, if the user selects a point along a road in a three-dimensional streetscape scene, the perspective and orientation may move to focus orthogonal to the ground, when the user merely intended to move the scene forward along the road, maintaining the original scene orientation. Thus, a method to allow a user to navigate a three-dimensional scene wherein the user understands the result of the selection of a point in the scene prior to the actual selection would reduce unexpected movements and improve navigation efficiency.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In one embodiment, a computer-implemented method may anticipate a movement of a three-dimensional scene from an imaginary camera from a first location and orientation of a imaginary camera to a second location and orientation of a imaginary camera via a user interface. The computer-implemented method may also include rendering a three-dimensional scene from the first location and a first orientation of the imaginary camera, and detecting a hovering event. The hovering event may include pointing via the user interface to a second location within the three-dimensional scene without confirming a selection of the second location for a predetermined period of time. The computer-implemented method may further include determining an appropriate second orientation corresponding to the second location, rendering an animated transition of the three-dimensional scene from the first location and the first orientation in the three-dimensional scene to the second location and the second orientation, and rendering an animated transition of the three-dimensional scene from the second location and second orientation to the first location and first orientation.

In another embodiment, a computer system may anticipate a movement of a three-dimensional scene from a first location and orientation of a imaginary camera and a second location and orientation via a user interface. The computer system may include one or more processors, one or more memories communicatively coupled to the one or more processors, one user interface communicatively coupled to the one or more processors, and one or more databases communicatively coupled to the one or more processors. The databases may store a plurality of three-dimensional scenes. The one or more memories may include computer executable instructions stored therein that when executed by the one or more processors cause the one or more processors to render the three-dimensional scene from a first location and a first orientation via a user interface. The computer executable instructions may further cause the one or more processors to detect a hovering event. The hovering event may include pointing via the user interface to the second location within the three-dimensional scene without confirming a selection of the second location for a predetermined period of time. The computer executable instructions may further cause the one or more processors to determine an appropriate second orientation corresponding to the second location, render an animated transition of the three-dimensional scene from the first location and the first orientation in the three-dimensional scene to the second location and the second orientation, and render an animated transition of the three-dimensional scene from the second location and second orientation to the first location and first orientation.

### BRIEF DESCRIPTION OF THE DRAWINGS

FIG. 1 is a high-level view of a stand-alone system for anticipating the action of a user with subtle camera motions;

FIG. 2 is a high-level view of a client-server system for anticipating the action of a user with subtle camera motions;

FIG. 3 is an illustration of a viewport including a three-dimensional scene and a subtle movement of the three-dimensional scene in a forward motion in response to a pointing device hover over on the front of a building;

FIG. 4 is an illustration of a viewport including a three-dimensional scene and a subtle movement of the three-dimensional scene forward and rotating in response to a pointing device hover over on the side of a building;

FIG. 5 is an illustration of a viewport including a three-dimensional scene with a hover over an icon not resulting in any movement of the scene;

FIG. 6 is an exemplary computing system that may implement various portions of the system for anticipating the action of a user with subtle camera motions.

FIG. 7 is an exemplary computing system that may implement various portions of the system for anticipating the action of a user with subtle camera motions.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

An image display system renders three-dimensional scenes on a display for a user that provides subtle camera motions, or motions of a imaginary camera rendered on a display that anticipate the future navigation actions of the user in the three-dimensional scene. Subtle preview motions, such as zooming, rotation, and forward movement, allow the user to understand how the location and orientation of the imaginary camera may change within the three-dimensional scene because of future navigation actions. Further, the user may avoid undesirable or unanticipated navigation within the three-dimensional scene because the subtle imaginary camera motions instruct the user of the result of future navigation actions prior to allowing the user to perform navigation actions.

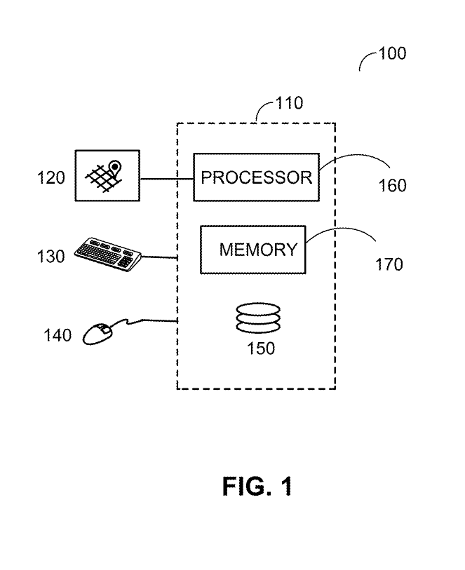

Turning to FIG. 1, a stand-alone image display system 100, which uses subtle imaginary camera motions to anticipate and preview the future navigation actions of a user, includes an image rendering unit 110 that generally stores and displays three-dimensional scenes on a display 120, and that accepts user inputs from a keyboard 130 and pointing device 140. The image rendering unit 110 stores three-dimensional scenes in a database 150 that a processor 160 retrieves and renders the three-dimensional scenes on the display 120 by executing instructions stored in a memory 170. Generally speaking, the processor 160 renders subtle imaginary camera motions on the display 120 in anticipation of a user navigation action, such as the click of a pointing device 140, by previewing the result of an anticipated user navigation, such as a change in location or orientation within the three-dimensional scene. The user observes the subtle imaginary camera motion and is instructed by the system of the result of a navigation action. Thus, the user of the system 100, observing the subtle imaginary camera motion may navigate the three-dimensional scene more effectively and avoid unanticipated or unexpected navigation actions.

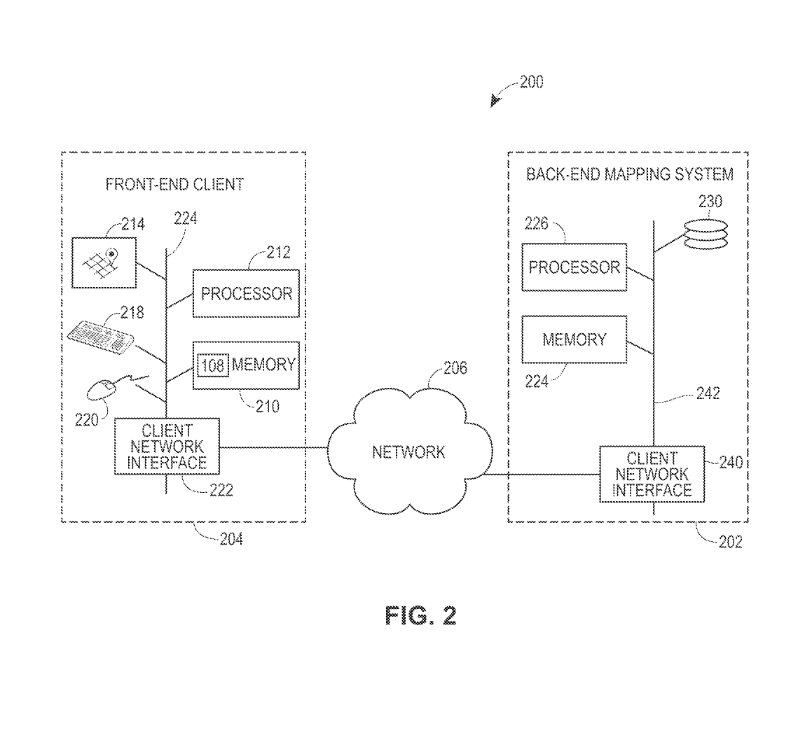

In another embodiment, for example the client-server system 200 illustrated in FIG. 2, the database containing three-dimensional scenes resides within a back-end server 202, instead of a singular image rendering unit 110 in the embodiment illustrated in FIG. 1. The system 200 generally renders a three-dimensional scene from the location and orientation of a imaginary camera in a viewport to subtly indicate the anticipated actions of a user as the user hovers over a point in the three-dimensional scene. Subtle indications include movement to a location and orientation near the hovered over point within a three-dimensional scene and returning to the original location and orientation. By subtly anticipating the action of the user with movements of the location and orientation of a imaginary camera, the user understands how the location and orientation of the imaginary camera rendered on the viewport may change with future user interactions. The system 200 generally includes a back-end mapping system 202 and a front-end client 204 interconnected by a network 206. The front-end client 204 includes executable instructions 208 contained in a memory 210, a processor 212, a display 214, a keyboard 218, a pointing device 220, and a client network interface 222 communicatively coupled together with a front-end client bus 224. The client network interface 222 communicatively couples the front-end client 204 to the network 206. The back-end mapping system 202 includes instructions 222 contained in a memory 224, a processor 226, a database containing three-dimensional scenes 230, and a back-end network interface 240 communicatively coupled together with a back-end mapping system bus 242.

Generally, the front-end client 204, executing instructions 208 in the processor 212, renders a three-dimensional scene retrieved from the scenes database 230 on the display 214. The user generally interacts with the front-end client 204 using a pointing device 220 and a keyboard 218 to hover over and select locations in the three-dimensional scene to navigate within the three-dimensional scene rendered on a display 214. Hovering over a particular point with the pointing device 220 in the three-dimensional scene sends a request to the back-end mapping system 202 to execute instructions 222 to retrieve an updated three-dimensional scene nearby the hovered over point from to the back-end mapping system 202 and transmit the new three-dimensional scene to the front-end client 204. The front-end client 204, executing instructions 208 subtly anticipates a user selection of the hovered over point by moving the location and orientation of a imaginary camera rendered on the viewport to the new three-dimensional scene retrieved from the back-end mapping system 202 and then returning to the original location and orientation of the imaginary camera rendered on the viewport.

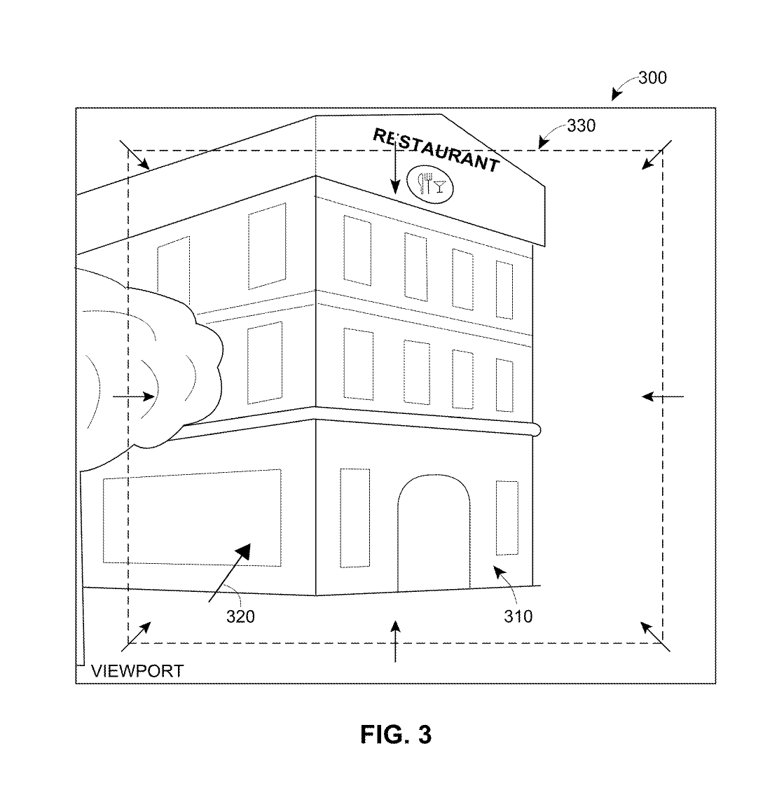

Turning to FIG. 3, a viewport 300 rendered in the display 214, includes a three-dimensional scene including a three-dimensional building 310 and a cursor 320 controlled by the pointing device 220. When the cursor 320 hovers over a point on a surface of the three-dimensional building 310, the viewport 300 renders the imaginary camera moving quickly, but elastically, forward to a new location and orientation 330. The new location and orientation of the imaginary camera 330 subtly indicates the future location and orientation of the imaginary camera if and when the user selects the point on the surface of the three-dimensional building 310 with the pointing device 220. Once the imaginary camera reaches the new location and orientation 330, the imaginary camera moves quickly, but elastically, back to the original location and orientation 300. Together, the movement forward to the position 330 and back to the position 300 comprises a subtle indication of the anticipated future action of the user. Thus, when the user at some point in the future selects the point on the three-dimensional building 310, the user already understands the future location and orientation of the imaginary camera. Based on the subtle movement of the imaginary camera, if the user for example determines that the previewed location and orientation 330 is unacceptable, the user may hover over another point on the three-dimensional building 310 to provide a more acceptable location or orientation. Thus, because the system 200 anticipates and previews the result of user actions, the user of the system 200 may more effectively navigate the three-dimensional scene rendered by the system 200.

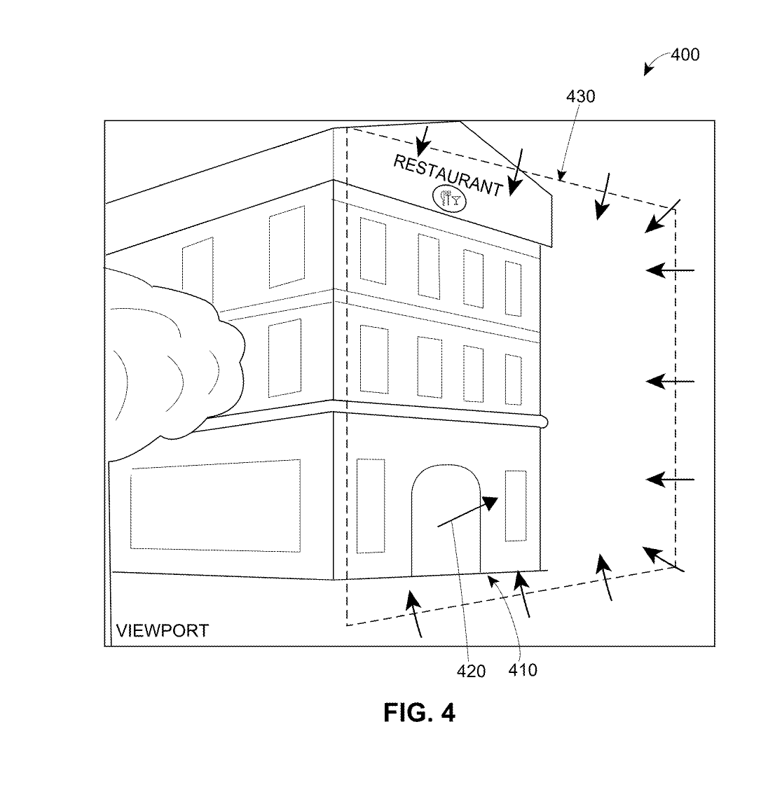

In a similar way, with reference to FIG. 4, a viewport 400 includes a rendered three-dimensional scene from the location and orientation of a imaginary camera including a three-dimensional building 410 and a cursor 420 controlled by the pointing device 220. When the cursor 420 hovers over a point on a surface of the three-dimensional building 410, the viewport 400 renders the imaginary camera moving quickly, but elastically forward as well as rotating to a location and orientation 430 orthogonal to the surface of the three-dimensional building 410. The new location and orientation of the imaginary camera 430 subtly indicates the future location and orientation of the imaginary camera if and when the user selects the point on the surface of the three-dimensional building 410. Once the imaginary camera reaches the new location and orientation 430, the imaginary camera moves quickly but elastically back to the original location and orientation of the imaginary camera rendered on the viewport 400. Together the movement of the imaginary camera forward to the position 430 and back to the position 400 comprises a subtle indication of the anticipated future action of the user. Thus, when the user at some point in the future selects the point on the three-dimensional building 410 the user already understands what the future location and orientation of the imaginary camera rendered on viewport will be. Based on the subtle movement of the viewport the user may determine that the previewed location and orientation 430 is unacceptable and may hover over another point on the three-dimensional building 410 to provide a more acceptable location or orientation.

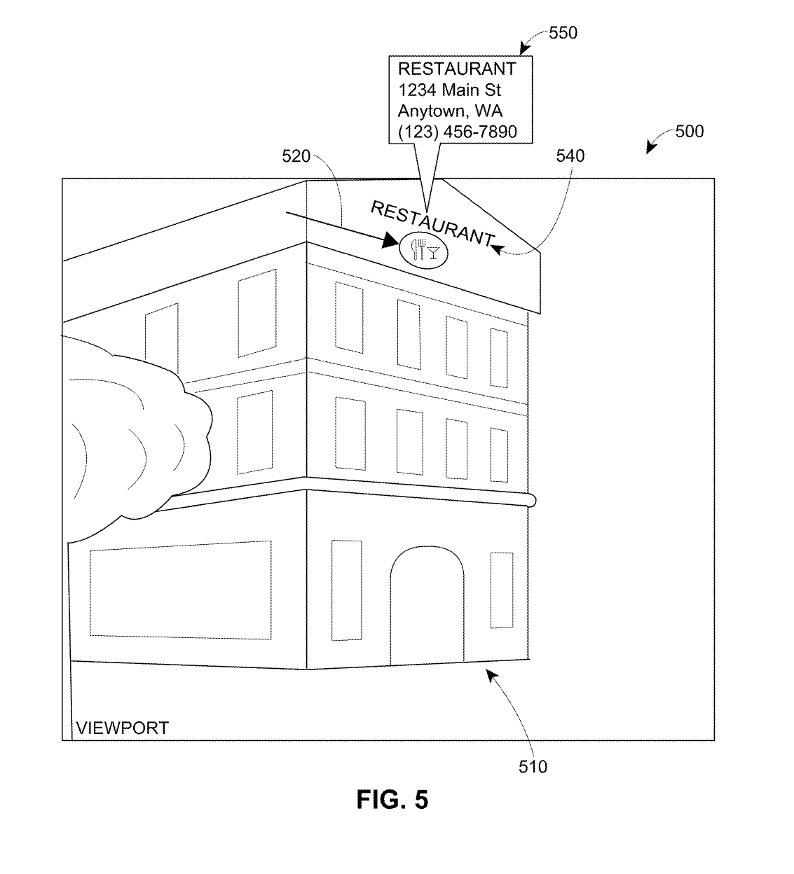

Alternatively, with reference to FIG. 5, a viewport 500 includes a rendered three-dimensional scene including a three-dimensional building 510 and a cursor 520 controlled by the pointing device 220. When the cursor 520 hovers over an icon 540 in the three-dimensional scene, the location and orientation of the imaginary camera rendered on the viewport 500 does not move to indicate a future position in anticipation of a selection. In the embodiment illustrated in FIG. 5, the viewport 500 renders an information window 550 with additional information about the hovered over icon 540 as an alternative to movement of the location and orientation of the imaginary camera rendered on the viewport in the embodiments illustrated in FIG. 3 and FIG. 4. By rendering an information window 550 during a hover over of the cursor 520 over the icon 540, the system 200 instructs the user that selecting the icon 540 will not move the imaginary camera to a different location and orientation, but alternatively brings up additional information regarding the hovered over icon 540. Thus, because the user receives instructions prior to attempting navigation, the user may more effectively navigate, or receive information about, the three-dimensional scene.

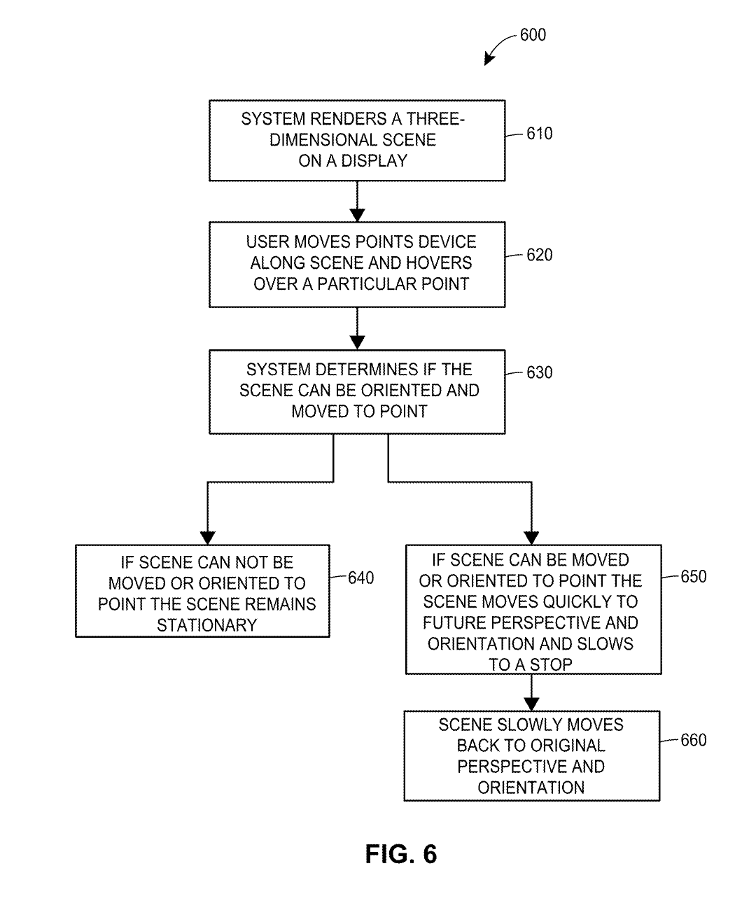

The flowchart illustrated in FIG. 6 illustrates a method 600 using the system 200 illustrated in FIG. 2 to render a three-dimensional scene on the display 214 and anticipate future actions of a user when hovering over points in the three-dimensional scene with subtle changes in the location and orientation of the imaginary camera rendered on the viewport. The method 600 begins at step 610 by executing instructions 208 in the processor 212 to send a request from the front-end client 204 to the back-end mapping system 202 via the network 206 to retrieve a three-dimensional scene from the scenes database 230. The back-end mapping system 202, executing instructions 222 retrieves the three-dimensional scene from the scenes database 230 and transmits the three-dimensional scene back to the front-end client 204 via the network 206. The front-end client 204, executing instructions 208, stores the three-dimensional scene in the memory 210, and renders the three-dimensional scene on the display 214 for the user.

The method 600 continues at step 620 where a user interacting with the system 200 using the pointing device 220 and keyboard 218 hovers over a particular point in the three-dimensional scene rendered on the display 214. Hovering over the particular point in the three-dimensional scene causes the processor 212 to retrieve an updated three-dimensional scene nearest the selected point in the three-dimensional scene if in fact a user interaction with that particular point would navigate the location and orientation of the imaginary camera rendered on the viewport.

If the hovered over point would result in a navigation if selected with the pointing device 220, then the processor 212, executing instructions 208 at step 630, transmits identifying information about the hovered over point in the three-dimensional scene to the back-end mapping system 202 via the network 206. The back-end mapping system 202, executing instructions 222 in the processor 226, retrieves the three-dimensional scene nearest the point identified by the front-end client 204 from the scenes database 230 and transmits the updated scene back to the front-end client 204 via the network 206. The front-end client 204, executing instructions 208 in the processor 212 stores the updated scene in the memory 210.

The processor 212, executing instructions 208 at step 650 then renders a change in the location and orientation of the imaginary camera within the three-dimensional scene on the display 214 to the new three-dimensional scene stored in the memory 210 at step 630. The rendered transition to the new three-dimensional scene stored in the memory 210 moves quickly at first then slows with an elastic effect when approaching the new location and orientation of the imaginary camera. Once the location and orientation of the imaginary camera rendered on the display 214 arrives at the new three-dimensional scene stored in the memory 210, the processor 212, executing instructions 208 at step 660, transitions the location and orientation of the imaginary camera within the three-dimensional scene rendered on the display 214 back to the original location and orientation of the imaginary camera quickly with the same elastic effect, moving slowly at first, then quickly. The completion of steps 650 and 660, moving the location and orientation of the imaginary camera within the three-dimensional scene in and then back out, anticipates the future selection of the point in the three-dimensional scene with a subtle motion indicating for the user the future result of selecting the point in the three-dimensional scene. Thus, the user now aware of the future result of selecting the point in the three-dimensional scene, may more effectively navigate the three-dimensional scene.

Alternatively, if the processor 214, executing instructions 208 at step 630 determines that the hovered over point would not result in a navigation if selected, then the processor 214, executing instructions 208 at step 630, does not transmit identifying information to the back-end mapping system 202. The processor 214 then executes instructions 208 at step 640 to not update the scene rendered on the display 214 and awaits further user interactions with the pointing device 220 or keyboard 218.

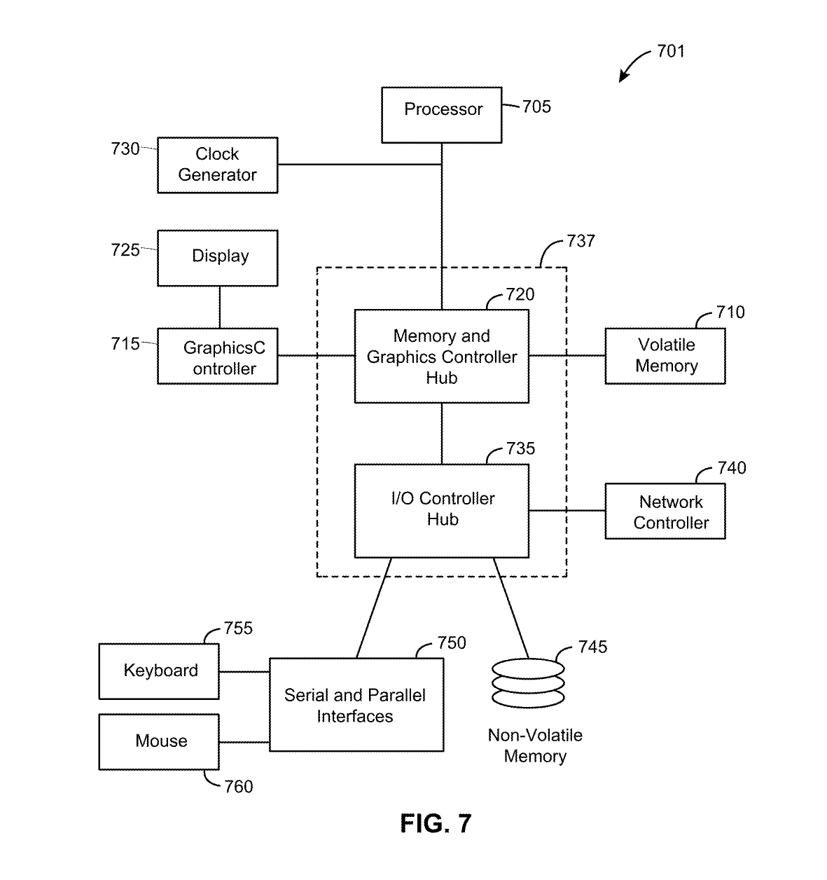

FIG. 7 illustrates a generic computing system 701 the system 200 may use to implement the front-end client 204 illustrated in FIG. 2, and/or the back-end mapping system 202. The generic computing system 701 comprises a processor 705 for executing instructions that may be stored in volatile memory 710. The memory and graphics controller hub 720 connects the volatile memory 710, processor 705, and graphics controller 715 together. The graphics controller 715 may interface with a display 725 to provide output to a user. A clock generator 730 drives the 705 processor and memory and graphics controller hub 720 that may provide synchronized control of the system 701. The I/O controller hub 735 connects to the memory and graphics controller hub 720 to comprise an overall system bus 737. The hub 735 may connect the lower speed devices, such as the network controller 740, non-volatile memory 745, and serial and parallel interfaces 750, to the overall system 701. The serial and parallel interfaces may 750 include a keyboard 755 and mouse 760 for interfacing with a user.

FIGS. 1-7 illustrate a system and method for anticipating a user action with subtle imaginary camera motions. The system comprises a front-end client that receives user interactions and displays and navigates three-dimensional scenes. The back-end mapping system retrieves three-dimensional scenes from databases. The method provides a subtle imaginary camera movement comprising a movement to a future position to anticipate a user action while navigating the three-dimensional scene.

The following additional considerations apply to the foregoing discussion. Throughout this specification, plural instances may implement processes, steps, functions, components, operations, or structures described as a single instance. Although individual functions and instructions of one or more processes and methods are illustrated and described as separate operations, the system may perform one or more of the individual operations concurrently, and nothing requires that the system perform the operations in the order illustrated. The system may implement structures and functionality presented as separate components in example configurations as a combined structure or component. Similarly, the system may implement structures and functionality presented as a single component as separate components. These and other variations, modifications, additions, and improvements fall within the scope of the subject matter herein.

For example, the network 406 may include but is not limited to any combination of a LAN, a MAN, a WAN, a mobile, a wired or wireless network, a private network, or a virtual private network. Moreover, while FIG. 4 illustrates only one client-computing device to simplify and clarify the description, any number of client computers or display devices can be in communication with the mapping system 400.

Additionally, certain embodiments are described herein as including logic or a number of components, modules, or mechanisms. Modules may constitute either software modules (e.g., code or instructions embodied on a machine-readable medium or in a transmission signal, wherein a processor executes the code) or hardware modules. A hardware module is tangible unit capable of performing certain operations and may be configured or arranged in a certain manner. In example embodiments, software (e.g., an application or application portion) may configure one or more computer systems (e.g., a standalone, client or server computer system) or one or more hardware modules of a computer system (e.g., a processor or a group of processors) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods, processes, or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments of a system for anticipating the actions of a user for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for a system for anticipating the actions of a user through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for anticipating a movement of an imaginary camera in a three-dimensional scene from a first location of the imaginary camera and a first orientation of the imaginary camera to a second location of the imaginary camera and a second orientation of the imaginary camera via a user interface the method comprising:
rendering the three-dimensional scene from the first location of the imaginary camera and the first orientation of the imaginary camera;
detecting a hovering event, wherein the hovering event comprises pointing via the user interface to the second location of the imaginary camera without confirming a selection of the second location of the imaginary camera for a predetermined period of time;
determining the appropriate second orientation of the imaginary camera corresponding to the second location of the imaginary camera;
rendering an animated transition of the three-dimensional scene by illustrating a motion of the imaginary camera traveling along a trajectory from the first location of the imaginary camera and the first orientation of the imaginary camera toward the second location of the imaginary camera and the second orientation of the imaginary camera; and
rendering an animated transition of the three-dimensional scene by illustrating a motion of the imaginary camera traveling along a trajectory from the second location of the imaginary camera and second orientation of the imaginary camera toward the first location of the imaginary camera and first orientation of the imaginary camera.

2. The computer-implemented method of claim 1 wherein the animated transition of the three-dimensional scene from the first location of the imaginary camera and the first orientation of the imaginary camera to the second location of the imaginary camera and second orientation of the imaginary camera comprises a linear motion from the first location of the imaginary camera to the second location of the imaginary camera.

3. The computer-implemented method of claim 1 wherein the animated transition of the three-dimensional scene from the first location of the imaginary camera and the first orientation of the imaginary camera to the second location of the imaginary camera and second orientation of the imaginary camera comprises a motion that begins quickly leaving the first location of the imaginary camera and slows to a stop as the imaginary camera approaches the second location of the imaginary camera.

4. The computer-implemented method of claim 1 wherein the animated transition of the three-dimensional scene from the second location of the imaginary camera and the second orientation of the imaginary camera to the first location of the imaginary camera and first orientation of the imaginary camera comprises a motion that begins slowly leaving the second location of the imaginary camera and ends quickly as the imaginary camera approaches the first location of the imaginary camera.

5. The computer-implemented method of claim 1 wherein the animated transition of the three-dimensional scene from the first location of the imaginary camera and the first orientation of the imaginary camera to the second location of the imaginary camera and second orientation of the imaginary camera comprises a rotation from the first orientation of the imaginary camera to the second orientation of the imaginary camera.

6. The computer-implemented method of claim 1 wherein the hovering event comprises pointing via the user interface to an icon at the second location of the imaginary camera without confirming a selection of the second location of the imaginary camera for a predetermined period of time.

7. The computer-implemented method of claim 6 wherein the method further comprises rendering an information window with additional information about the icon at the second location of the imaginary camera.

8. A computer system for anticipating a movement of a imaginary camera in a three-dimensional scene from a first location of the imaginary camera and first orientation of the imaginary camera to a second location of the imaginary camera and second orientation of the imaginary camera via a user interface, the system comprising:
one or more processors;
one or more memories communicatively coupled to the one or more processors;
one or more databases communicatively coupled to the one or more processors, the databases storing at least one three-dimensional scene; and
one user interface communicatively coupled to the one or more processors;
wherein the one or more memories include computer executable instructions stored therein that, when executed by the one or more processors, cause the one or more processors to:
render the three-dimensional scene from the first location of the imaginary camera and a first orientation of the imaginary camera;
detect a hovering event, wherein the hovering event comprises pointing via the user interface to the second location of the imaginary camera without confirming a selection of the second location of the imaginary camera for a predetermined period of time;
determine the appropriate second orientation of the imaginary camera corresponding to the second location of the imaginary camera;
render an animated transition of the three-dimensional scene by illustrating a motion of the imaginary camera traveling along a trajectory from the first location of the imaginary camera and the first orientation of the imaginary camera in the three-dimensional scene toward the second location of the imaginary camera and the second orientation of the imaginary camera; and
render an animated transition of the three-dimensional scene by illustrating a motion of the imaginary camera traveling along a trajectory from the second location of the imaginary camera and second orientation of the imaginary camera in the three-dimensional scene toward the first location of the imaginary camera and the first orientation of the imaginary camera.

9. The computer system of claim 8 wherein the computer executable instructions, when executed by the one or more processors, cause the one or more processors to render the animated transition of the three-dimensional scene from the first location of the imaginary camera and the first orientation of the imaginary camera to the second location of the imaginary camera and second orientation of the imaginary camera in a linear motion from the first location of the imaginary camera to the second location of the imaginary camera.

10. The computer system of claim 8 wherein the computer executable instructions, when executed by the one or more processors, cause the one or more processors to render the animated transition of the three-dimensional scene from the first location of the imaginary camera and the first orientation of the imaginary camera to the second location of the imaginary camera and second orientation of the imaginary camera with a motion that begins quickly leaving the first location of the imaginary camera and slows to a stop as the imaginary camera approaches the second location of the imaginary camera.

11. The computer system of claim 8 wherein the computer executable instructions, when executed by the one or more processors, cause the one or more processors to render the animated transition of the three-dimensional scene from the second location of the imaginary camera and second orientation of the imaginary camera to the first location of the imaginary camera and first orientation of the imaginary camera with a motion that begins slowly leaving the second location of the imaginary camera and ends quickly as the imaginary camera approaches the first location of the imaginary camera.

12. The computer system of claim 8 wherein the computer executable instructions, when executed by the one or more processors, cause the one or more processors to render the animated transition of the three-dimensional scene from the first location of the imaginary camera and the first orientation of the imaginary camera to the second location of the imaginary camera and second orientation of the imaginary camera including a rotation from the first orientation of the imaginary camera to the second orientation of the imaginary camera.

13. The computer system of claim 8 wherein the computer executable instructions, when executed by the one or more processors, cause the one or more processors to detect a hovering event, wherein the hovering event comprises pointing via the user interface to an icon at the second location of the imaginary camera without confirming a selection of the second location of the imaginary camera for a predetermined period of time.

14. The computer system of claim 13 wherein the computer executable instructions, when executed by the one or more processors, cause the one or more processors to render an information window with additional information about the icon at the second location of the imaginary camera .

15. The computer system of claim 8, wherein the computer executable instructions, when executed by the one or more processors, cause the one or more processors to determine that the appropriate second orientation is an orientation orthogonal to the surface of the second location.

16. The computer-implemented method of claim 1 wherein the method further comprises determining that the appropriate second orientation is an orientation orthogonal to the surface of the second location.

17. A computer-implemented method for anticipating a movement of an imaginary camera in a three-dimensional scene from a first location of the imaginary camera and a first orientation of the imaginary camera to a second location of the imaginary camera and a second orientation of the imaginary camera via a user interface the method comprising:
rendering the three-dimensional scene from the first location of the imaginary camera and the first orientation of the imaginary camera;
detecting a hovering event, wherein the hovering event comprises pointing via the user interface to the second location of the imaginary camera without confirming a selection of the second location of the imaginary camera for a predetermined period of time;
in response to determining that the second location is a location of an icon:
generating an information window including information related to the second location;
otherwise:
(i) determining the appropriate second orientation of the imaginary camera corresponding to the second location of the imaginary camera,
(ii) rendering a first animated transition of the three-dimensional scene by illustrating a motion of the imaginary camera traveling along a trajectory from the first location of the imaginary camera and the first orientation of the imaginary camera toward the second location of the imaginary camera and the second orientation of the imaginary camera, and
(iii) rendering a second animated transition of the three-dimensional scene by illustrating a motion of the imaginary camera traveling along a trajectory from the second location of the imaginary camera and second orientation of the imaginary camera toward the first location of the imaginary camera and first orientation of the imaginary camera.
